(19) United States
(12) Patent Application Publication
(10) Pub. No.: US 2025/0274485 A1
(43) Pub. Date: Aug. 28, 2025

(54) AI- Powered smart Wireless Router with Integrated Environmental Sensing and Cybersecurity System

(71) Applicant: Imran Khurshid Alam, Plano, TX (US)

(72) Inventor: IMRAN KHURSHID ALAM, Plano, TX (US)

(73) Assignee: Imran Khurshid Alam, Plano, TX (US)

(21) Appl. No.: 19/201,469

(22) Filed: May 7, 2025

(51) Int. Cl. H04L 9/40; H04W 12/128; H04W 12/65

(52) U.S. Cl. CPC H04L 63/1441; H04L 63/1425; H04W 12/128; H04W 12/65

(57) ABSTRACT

An AI-powered wireless router providing adaptive network optimization through integrated machine learning algorithms, sensor-based environment and behavior monitoring and real-time proactive cybersecurity. The router continuously analyzes network traffic, user behavior and environmental factors to optimize Wi-Fi performance and manage IoT devices. Advanced cybersecurity features autonomously detect and mitigate threats, ensuring network security and integrity. Integrated environmental sensing capabilities monitor temperature, humidity and air quality, enabling smart home automation and energy efficiency. The AI-driven approach adapts to changing network conditions, user behavior and emerging threats, providing robust and secure networking. This innovative router offers unparalleled performance, security and intelligence, making it an ideal solution for homes and businesses seeking reliable and secure wireless connectivity. By leveraging AI and machine learning, the router ensures optimal network performance, detects potential threats and provides a secure and efficient networking experience.

### FIELD OF INVENTION

The present invention relates to a smart wireless router that utilizes artificial intelligence (AI) to enhance network performance, manage Internet of Things (IoT) devices and provide robust cybersecurity measures. More specifically, it pertains to a wireless router that integrates machine learning algorithms, environmental sensors and advanced cybersecurity features to optimize bandwidth, monitor environmental conditions and protect against cyber threats.

### BACKGROUND OF INVENTION

The rapid proliferation of Internet of Things (IoT) devices and the increasing demand for high-speed internet connectivity have underscored the need for advanced networking solutions. Traditional wireless routers often struggle to manage the growing complexity of connected devices, leading to suboptimal performance, security vulnerabilities and user dissatisfaction. As a result, there is a pressing need for a new generation of routers that can intelligently adapt to dynamic network conditions while ensuring robust cybersecurity. The invention of the AI-powered smart wireless router with integrated environmental sensing and cybersecurity capabilities addresses these challenges by leveraging cutting-edge technologies. By incorporating machine learning algorithms, the router can analyze network traffic patterns, user behavior and environmental factors in real-time. This adaptive network optimization allows for enhanced Wi-Fi performance, ensuring that users experience minimal latency and maximum throughput, even in environments with multiple competing signals. Furthermore, the integration of RF signal sensor-based environmental monitoring enables the router to assess the physical surroundings, optimizing device placement and connectivity based on real-time data. This feature is particularly beneficial in smart homes and offices, where the density of IoT devices can lead to interference and connectivity issues. In addition to performance enhancements, the router's proactive cybersecurity measures are crucial in today's digital landscape, where cyber threats are increasingly sophisticated. By autonomously detecting anomalies and potential threats, the router can implement mitigation strategies in real-time, safeguarding user data and privacy without requiring manual intervention. This dual focus on performance and security positions the router as a comprehensive solution for modern networking needs. Overall, the invention represents a significant advancement in wireless networking technology, combining AI-driven optimization, environmental awareness and robust cybersecurity into a single device. This innovative approach not only enhances user experience but also addresses the critical challenges posed by the growing number of connected devices and the evolving landscape of cyber threats, making it a vital tool for both consumers and businesses alike.

### SUMMARY OF INVENTION

The invention relates to an AI-powered smart wireless router that integrates advanced technologies for adaptive network optimization, environmental sensing and comprehensive cybersecurity. As the demand for high-speed internet and the proliferation of Internet of Things (IoT) devices continue to rise, traditional wireless routers often struggle to manage the complexities of modern networking environments. This invention addresses these challenges by leveraging artificial intelligence and machine learning to enhance user experience and security. At the heart of this invention is the router's ability to utilize integrated machine learning algorithms for continuous analysis of network performance. By monitoring various parameters such as bandwidth usage, signal strength and user behavior, the router can make real-time adjustments to optimize Wi-Fi connectivity. This adaptive network optimization ensures that users experience minimal latency and maximum throughput, even in environments with multiple competing signals. The router intelligently allocates bandwidth based on the specific needs of connected devices, prioritizing critical applications and ensuring seamless streaming, gaming and browsing experiences. In addition to performance optimization, the router incorporates sensor-based environmental monitoring capabilities. These sensors assess factors such as RF signal strength, interference from other devices and power consumption. By gathering this data, the router can dynamically adjust its operations, optimizing device placement and connectivity based on real-time conditions. This feature is particularly beneficial in smart homes and offices, where the density of IoT devices can lead to connectivity issues and degraded performance. The invention also places a strong emphasis on cybersecurity, recognizing the increasing threats posed by cybercriminals in today's digital landscape. The router is equipped with advanced cybersecurity features, including an AI-driven firewall that autonomously detects and mitigates potential security risks. This proactive approach to cybersecurity allows the router to identify anomalies in network traffic and respond to threats in real-time, safeguarding user data and privacy without requiring manual intervention. Furthermore, the router includes real-time malware detection capabilities, ensuring that any malicious activity is promptly addressed. By continuously scanning for threats, the router can protect connected devices from viruses, ransomware and other forms of malware. Additionally, the router supports encrypted DNS and VPN routing, providing users with enhanced privacy and security for their online activities. This combination of features not only fortifies network security but also empowers users to browse the internet with confidence, knowing that their data is protected. Moreover, the router's energy control features contribute to its eco-friendly design. By optimizing power consumption based on usage patterns and environmental conditions, the router minimizes energy waste, making it a sustainable choice for consumers and businesses alike. This focus on energy efficiency aligns with the growing demand for environmentally responsible technology solutions. In summary, this invention represents a significant advancement in wireless networking technology, merging AI capabilities with environmental sensing and robust cybersecurity to create a smart router that meets the demands of today's digital landscape.

### DETAILED DESCRIPTION OF INVENTION

The present invention addresses these limitations by providing an AI-powered smart wireless router with integrated environmental sensing and cybersecurity system. The router leverages machine learning algorithms, sensor-based monitoring and advanced cybersecurity features to provide adaptive network optimization, effective IoT device management and real-time proactive cybersecurity. The AI-powered smart wireless router comprises, AI-Powered Decision-Making, the router's AI-powered decision-making capabilities enable adaptive network optimization, IoT device management and proactive cybersecurity. Machine Learning Algorithms, the router's machine learning algorithms enable continuous learning and improvement, ensuring optimal network performance and security. Sensor-Based Monitoring, the router's sensor-based monitoring capabilities enable real-time monitoring of environmental factors, such as temperature, humidity and air quality, as well as network performance metrics such as RF signal strength and power consumption. Advanced Cybersecurity Features, the router incorporates advanced cybersecurity features, including an AI-powered firewall, real-time malware detection, encrypted DNS and VPN routing. IoT Device Management, the router effectively manages IoT devices, ensuring seamless connectivity and optimal performance. The router incorporates an AI-driven firewall that continuously monitors incoming and outgoing traffic for suspicious activity. Real-time malware detection capabilities allow the router to identify and block potential threats before they can compromise the network. Encrypted DNS services protect user privacy by preventing DNS hijacking and ensuring secure browsing. The router supports VPN routing, allowing users to connect to a virtual private network for enhanced security and anonymity online. In User Interface and Control, the router features a user-friendly interface accessible via a mobile app or web portal, allowing users to monitor network performance, manage connected devices and configure settings. Users can receive real-time alerts regarding network performance issues, environmental changes or potential security threats. The app provides insights and recommendations for optimizing network performance based on user behavior and environmental conditions. Energy Efficiency, the router is designed to minimize power consumption through intelligent energy control mechanisms. It can enter low-power modes during periods of inactivity or adjust its operational parameters based on environmental conditions to reduce energy usage. Scalability and Future-Proofing, the router's architecture allows for easy updates and integration of new features as technology evolves. It can support future advancements in AI, IoT and cybersecurity, ensuring long-term usability and relevance. In hardware overview the AI-powered smart wireless router comprises, Multi-Core Processor which enables efficient processing of complex algorithms and multiple tasks. Al Chip/Module accelerates AI-driven decision-making and analytics. 5 GHz and 2.4 GHz Antenna Array provides dual-band Wi-Fi connectivity and optimal network coverage. Environmental Sensors monitors temperature, humidity and other environmental factors. RF Signal Strength Detectors monitors RF signal strength and optimizes network performance. Power Monitoring ICs tracks power consumption and optimizes energy efficiency. Ports includes USB, Ethernet, SIM and power input ports for connectivity and expansion. The AI-powered smart wireless router's software features include, AI Bandwidth Management which utilizes historical and predictive analytics to optimize bandwidth allocation. Sensor-Based Adaptive Transmission adjusts transmission power and parameters based on environmental and network conditions. AI Firewall detects and blocks cyber threats in real-time. Integrated Encrypted DNS provides secure DNS resolution and protects against DNS-based attacks. VPN Routing enables secure and private network access. Mobile App provides real-time alerts, device control and parental settings. The AI-powered smart wireless router with integrated environmental sensing and cybersecurity system offers numerous advantages. It provides adaptive network optimization through AI-driven bandwidth management and RF signal routing, ensuring optimal network performance. The router's advanced cybersecurity features, including an AI-powered firewall and real-time malware detection, enhance threat detection and mitigation. Additionally, the router enables smart home automation through environmental sensors and device control, while optimizing energy consumption through sensor-based adaptive transmission and power monitoring. The mobile app provides real-time alerts and device control, allowing users to monitor and manage their network remotely. Overall, the AI-powered smart wireless router improves network reliability, increases productivity and provides a secure and efficient networking solution for homes, businesses and IoT applications.

### DESCRIPTION OF DRAWINGS

FIG. 1 Shows the Front View of the Smart Router in which, 106 Indicates the front side of the router in which, 102 shows network sensor indicator which displays the status of the network, 103 shows security status which indicate the security state of device, 104 is the product logo area for branding or identification of the product, 105 is environment Sensor Window which is a section for environment sensing components and 101 shows the wireless router.

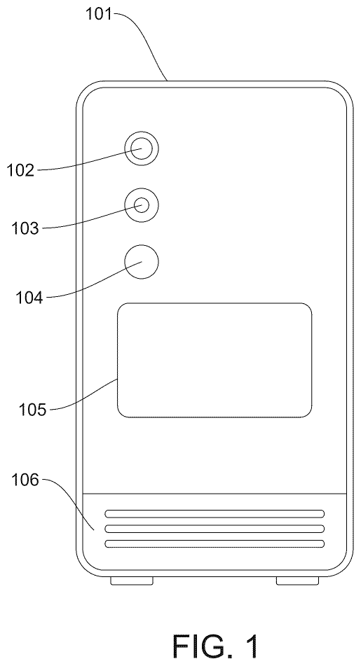

FIG. 2 Shows the Rear view of the Smart Router 111 shows USB ports the Connection points for USB devices. Power Input is Port for connecting to a power source. SIM Card Slot for inserting a SIM card, suggesting mobile connectivity capabilities. 100 shows the reset button for resetting the router. 112 shows the top position of the smart router. The drawing visually represents a technology product designed for efficient wireless networking. It indicates features focused on security and environmental monitoring.

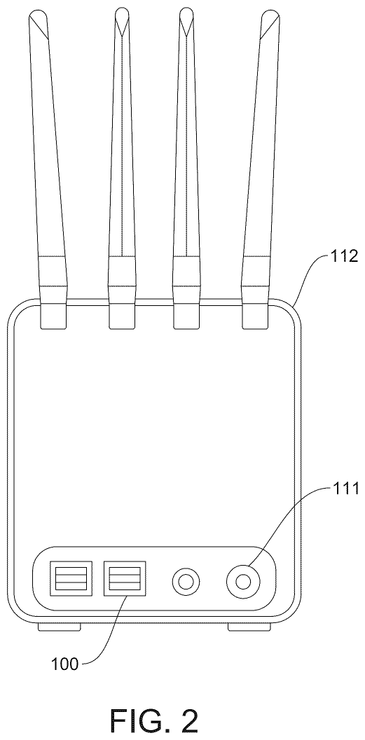

FIG. 3 Shows the internal Component Layout of an AI-Powered Smart Router with Environmental Sensing and represents the overall design of the smart router. The component, 201 is Main Circuit Board, 202 is Multi-core Processor, 203 is AI Chip/Module, 205 is Flash Storage, 206 is Power Management IC, 209 is Cooling Fan and 210 is for Wi-Fi Module. This provides crucial functionalities for the smart router, such as processing (multi-core processor, RAM), communication (Wi-Fi module) and management (power management IC, cooling fan). This is the comprehensive view of the internal workings and essential parts of a modern smart router equipped with AI capabilities and environmental sensing.

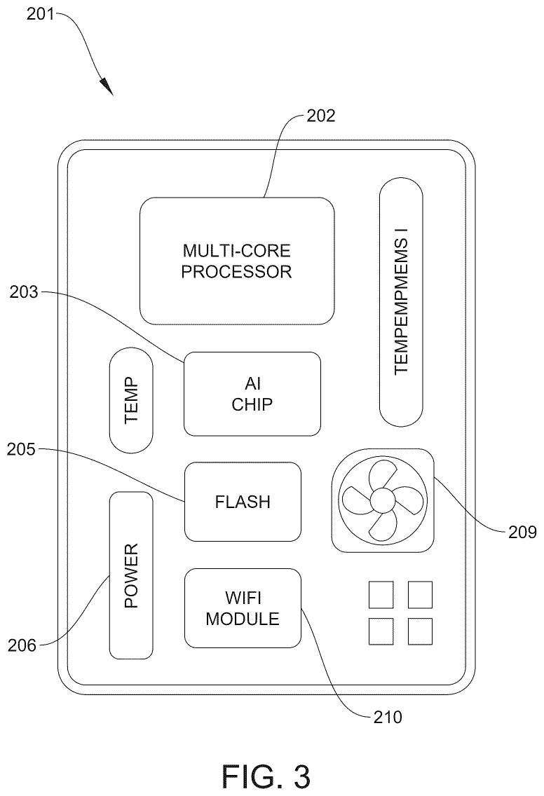

FIG. 4 Is System Architecture Block Diagram organized into several components, each depicted as separate blocks connected by lines indicating their relationships. Main Components are, 401 the Multi-Core CPU, located at the top left, this block indicates the processing unit. AI Modules 402, situated below the Multi-Core CPU, it represents the artificial intelligence capabilities of the system. Wireless Modules 405, Found at the top right, this block comprises modules for wireless communication (e.g., Wi-Fi, LTE, 5G). Sensor array positioned below the Wireless Modules this block signifies various sensors used in the system. System Bus, centered below the CPU and adjacent to the AI and Sensor Array representing communication pathways between components. Memory and Storage 403, located below the System Bus, indicating data storage capabilities. Interface Controllers 408, positioned in the bottom right, managing the connections to external devices.

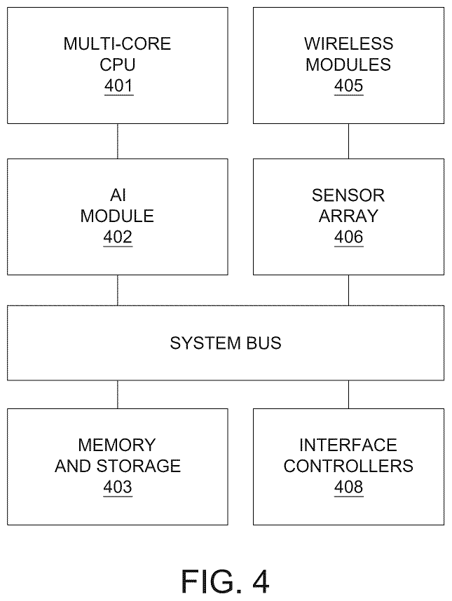

FIG. 5 shows Sensor input/output flow in this sensors are, Temperature Sensor (501) monitors the ambient temperature, Humidity Sensor (502) measures the humidity levels in the environment. 2.4 GHZ RF Sensor (503) detects signals in the 2.4 GHz frequency range, useful for Wi-Fi communication. 5 GHz RF Sensor (504) monitors the 5 GHz frequency range, providing insights into wireless network activity. Power Monitor (505) Tracks the power usage of the router to optimize energy efficiency. In Data Processing there is Sensor Data Collection & Preprocessing (506). This block aggregates the data from all sensors, processes it and prepares it for analysis or decision-making. The system appears to integrate environmental sensing capabilities into a wireless router. This allows for improved energy management and potentially enhanced network performance based on environmental conditions.

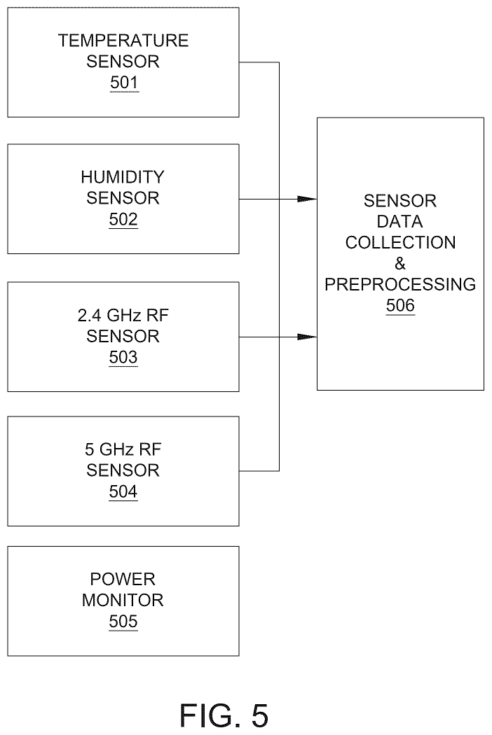

FIG. 6 Shows AI cybersecurity Control Logic in which main components are Network Traffic, Central input for monitoring and analyzing traffic. Traffic Analysis Module, analyzes the incoming network traffic. Threat Intelligence Database, stores data on known threats to enhance security measures. Pattern Recognition Engine, Identifies patterns in network traffic to detect anomalies. AI Decision Engine (Firewall Logic) makes decisions on whether to block or route traffic based on analysis. In the processes Traffic flows from Network Traffic to the Traffic Analysis Module and Threat Intelligence Database. The analysis leads to pattern recognition for identifying potential threats. Decisions made by the AI Decision Engine result in actions to either BLOCK or ROUTE the traffic. Output Components are Encrypt Traffic, ensures secure handling of network data. Encrypted DNS Module, divided into two modules for enhanced security. In VPN Module, additional security layer providing virtual private network services. This structured logic flow illustrates how the AI-powered router processes and secures network traffic, the workflow of network management. Step 702, Monitor Network Traffic & Application Usage, actively tracks usage across the network and applications. Step 703, Classify Traffic by Application & Priority, sorts network traffic based on the application type and priority level. Decision Point, Congestion Detection (Step 705), a decision node determines if network congestion is detected. Conditional Paths, If Congestion Detected? Yes Path, goes to Step 706 Adaptive Mode. Step 708, apply AI-Based Bandwidth Prioritization leveraging advanced analytics and encryption techniques for enhanced cybersecurity.

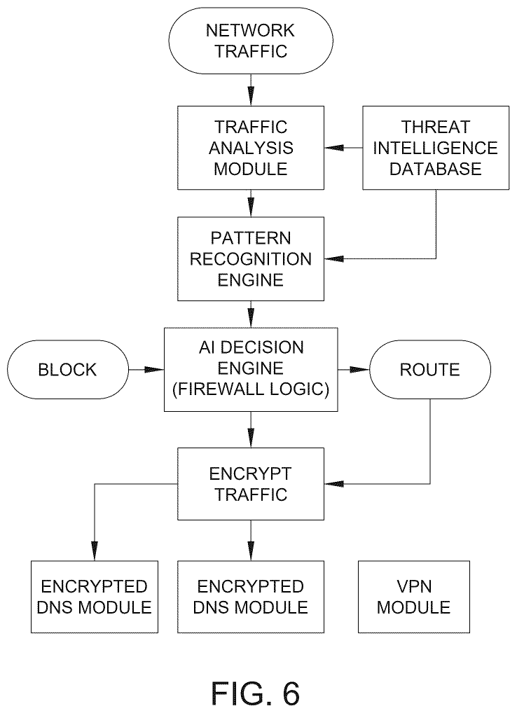

FIG. 7 Illustrates a flowchart for an AI-Powered Smart Wireless Router with Environmental Sensing that focuses on adaptive bandwidth management in which Key Components are, Start Symbol, Indicated in shape, starting the process of traffic monitoring. The Process Steps are Step 701, Start, Initiates Implements AI solutions to manage and prioritize bandwidth. If No Path goes to Step 704. Standard Mode continues regular operation without modifications. The flowchart indicates a systematic approach for ensuring optimal performance of the router by leveraging Al to adapt to network conditions effectively.

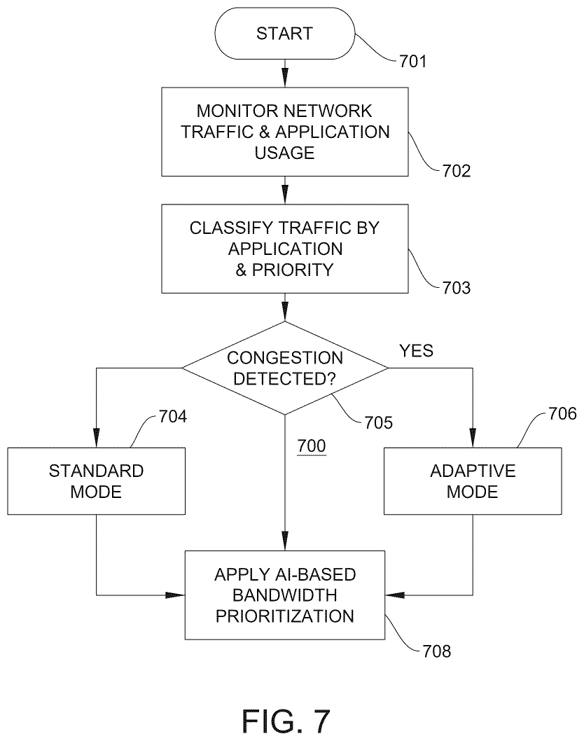

FIG. 8 Depicts a mobile device interface for a smart router designed to integrate AI capabilities, environmental sensing and advanced cybersecurity features. Key Elements includes Header (802) it indicates the title “SMART ROUTER” prominently displayed at the top of the interface. 804, Network Status Section includes WI-FI Status which Indicates “WIFI: ACTIVE” showing that the router's WI-FI feature is currently operational. Security Status displays “SECURITY: OPTIMAL” suggesting a high level of security measures are in effect. Connected Devices Section, a space reserved to show connected devices. 805 includes Environmental Data Section includes Temperature, displays the current temperature as “TEMP: 24° C. Humidity shows the humidity level as “HUMIDITY: 45%,” indicating the environmental monitoring capabilities of the router. In Settings Panel (809) options available for user adjustments include, Security Settings the Parameter for managing security features. Encrypted DNS toggle for enabling or disabling encrypted DNS services. VPN control for utilizing a Virtual Private Network feature. Buttons includes Settings (806) a button for accessing router settings. Controls (808) a button for additional controls related to router functions. Overall Functionality is that smart router interface allows users to monitor and manage network connectivity and security while also tracking environmental conditions, enhancing both the functional and security aspects of smart home technology.

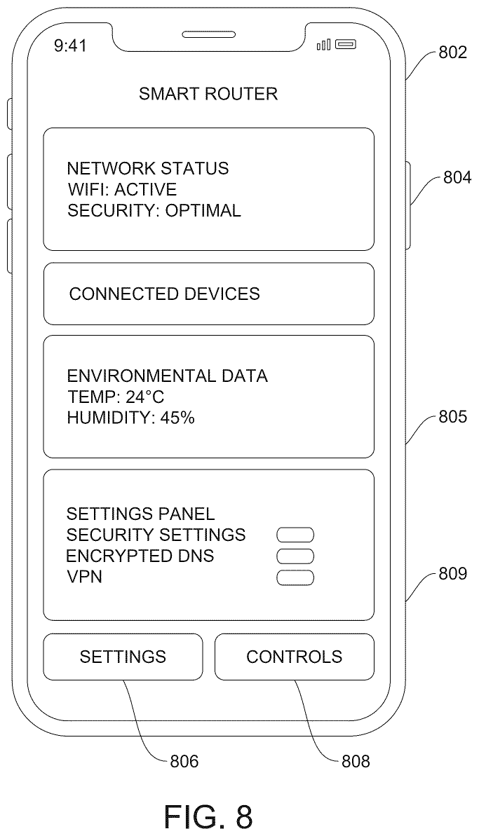

FIG. 9 Depicts a smart wireless router that integrates environmental sensing and cybersecurity systems. The router has a compact, rectangular design. Multiple antennae are protruding from the top, suggesting enhanced wireless connectivity. The device has visible ports on the side, likely for Ethernet and power connections. Key Features are, AI-Powered, the routing system is smart, utilizing AI for enhanced performance and decision-making. Environmental Sensing, symbols indicating environmental sensing capabilities, possibly detecting factors like air quality or temperature. Cybersecurity System, Implied safety features to protect against online threats. Additional Elements includes Connectivity Indicators, Icons representing wireless signals and global connectivity, showcasing the device's capabilities. Circuit Patterns, Lines and circuit patterns extend from the router, perhaps representing data flow or electrical connections. The router is positioned as a multifunctional device, merging internet connectivity with environmental monitoring, all secured with advanced cybersecurity measures.

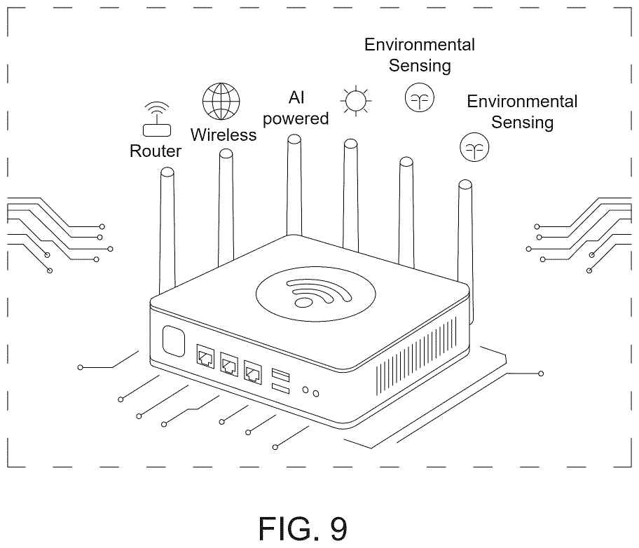

FIG. 10 Represents an AI-powered wireless router, showcasing modern technological features. Design Elements includes Antennae, the device has multiple antennae (four visible) that suggest enhanced signal strength and coverage for wireless communication. Body Structure, the router has a square or rectangular body adorned with various patterns that may indicate processing capabilities or ventilation for cooling. Key Features Indicated, Wireless Connectivity, clearly marked by a symbol, emphasizing the router's primary function of providing internet access. AI-Powered, the label “AI-powered Wireless Router” suggests advanced features such as adaptive learning for network optimization and intelligent data management. SiB (System in a Box), a feature that likely integrates multiple functionalities into a single device, enhancing usability. Environmental Sensing, this capability indicates that the router can monitor environmental factors, possibly contributing to energy efficiency or smart home integrations. Connectivity Ports, located on one side of the device, there are multiple ports indicating wired connectivity options, enhancing versatility.

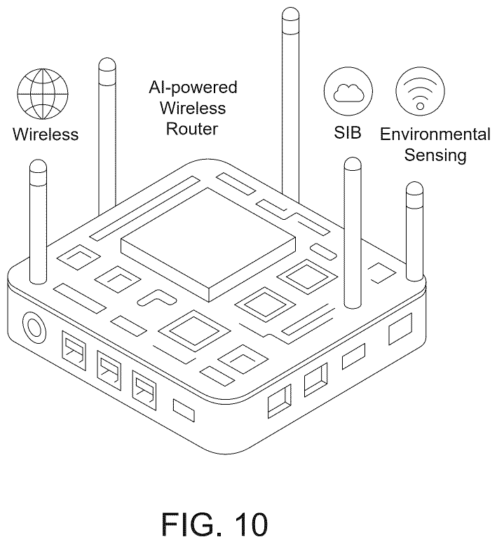

FIG. 11 Depicts a smart wireless router, which is likely designed to function with AI capabilities. It features several antennas protruding from its body, indicating enhanced wireless connectivity and performance. The router has a diamond or hexagonal shape, which might help in efficient signal distribution. Various ports are visible on one side of the router, suggesting multiple connectivity options for devices. Integrated Features are, the router incorporates environmental sensing technology, which could include sensors for monitoring conditions such as temperature, humidity or air quality. A cybersecurity system is integrated, aimed at protecting connected devices from potential threats. Surrounding the router are multiple smaller components, which might represent, chips or modules for processing and connectivity, various sensors or circuit boards that enhance functionality and specific designs that indicate functionality related to environmental monitoring and cybesecurity.

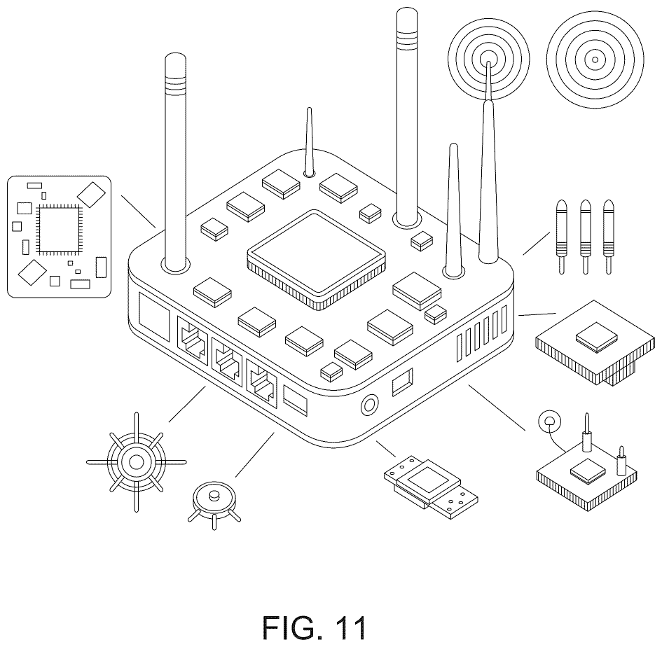

FIG. 12 Features a smart wireless router, visually represented as a compact, rectangular device equipped with a grid of buttons or lights on its surface. In Environmental Sensing, several components include antennas (indicated by vertical lines) surrounding the router, designed for environmental sensing. These could signify capabilities to monitor factors such as air quality or temperature. Additional components that suggest enhanced cybersecurity features, possibly including encryption modules or secure connections. A visible chip or electronic component labeled “security” may indicate these functionalities. An element depicted as a battery or energy source with a lightning bolt symbol suggests that the router is powered through a smart energy system, hinting at renewable or sustainable energy use. The illustration includes a smartphone, indicating that users can monitor or control the router through a mobile application. Other components may represent additional connected devices like sensors or cameras

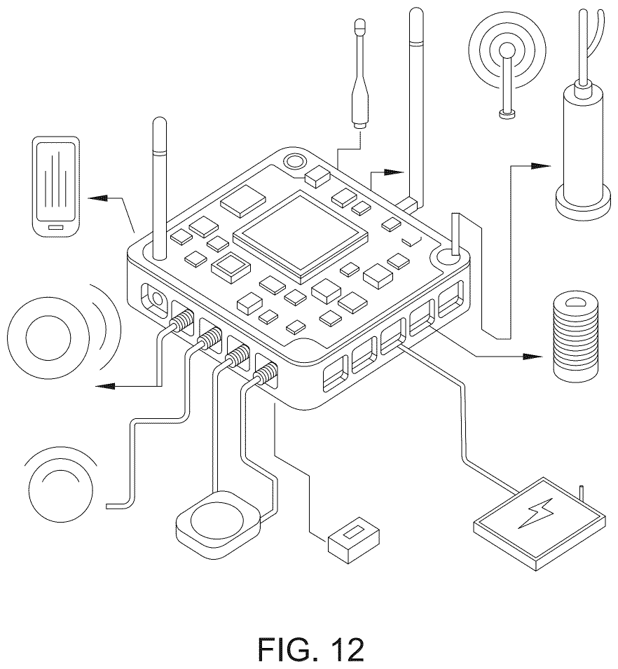

FIG. 13 Shows the Key Elements which are, Central Router Component, at the center there is a stylized router design depicted with a grid of multiple small squares representing various functionalities. It has several antennas extending from its sides, indicating wireless communication capabilities. Environmental Sensing, surrounding the router are various elements that suggest environmental sensors, such as air quality monitors and temperature sensors. These components are depicted in a simplistic manner, focusing on their connectivity to the main router. Cybersecurity System, the drawing features symbols that represent a cybersecurity framework, potentially including locks or shields, symbolizing protection against cyber threats. These elements are visually connected to the router, indicating their integration into the system. Connectivity Icons, additional towers are shown transmitting signals to and from the central router, demonstrating the device's ability to communicate with other networks and entities. Wi-Fi signals are illustrated emanating from the router, emphasizing wireless capabilities. Supplementary Devices, other small devices depicted may represent smart home appliances or connected vehicles that leverage the router's capabilities. These devices emphasize the practical applications and the interconnected nature of the system.

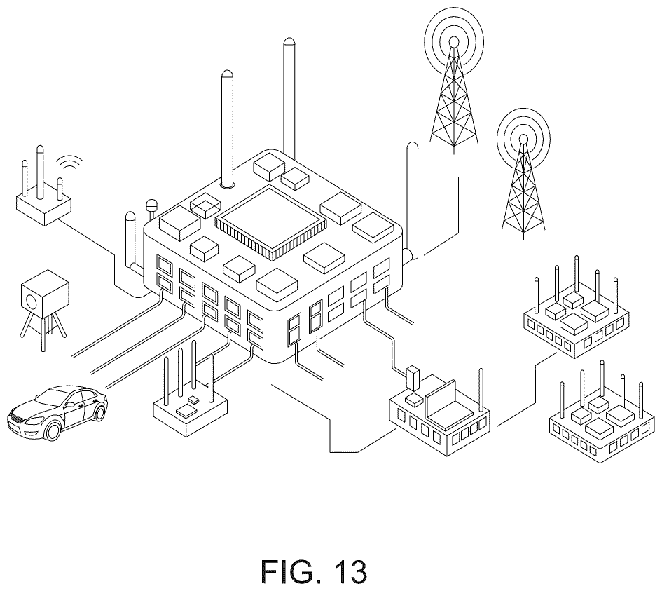

FIG. 14 Shows the router is illustrated with a rectangular, streamlined design. Multiple ports are present on the front for network connections. Components and Features includes, Environmental Sensors, detected by a microchip symbol indicating various environmental data collection. Cybersecurity System, highlighted with a digital lock symbol, suggesting robust security measures. VPN Functionality, a label indicates “VPN ENCRYPTED FIRMWARE UPDATES”, emphasizing secure updates. In Connectivity there are connections, lines connect the router to various components, indicating data flow. Laptop, shown connected to the router, representing end-user access. Additional Elements includes Integrated Microchips, Symbolizes advanced processing capabilities. Wireless Signal Representation, represents signals emanating from the router emphasize its wireless functionality. In environmental Indicator a sensor icon is present representing environmental monitoring capabilities. This visual accentuates an advanced networking device, showcasing its capabilities in an interconnected smart environment.

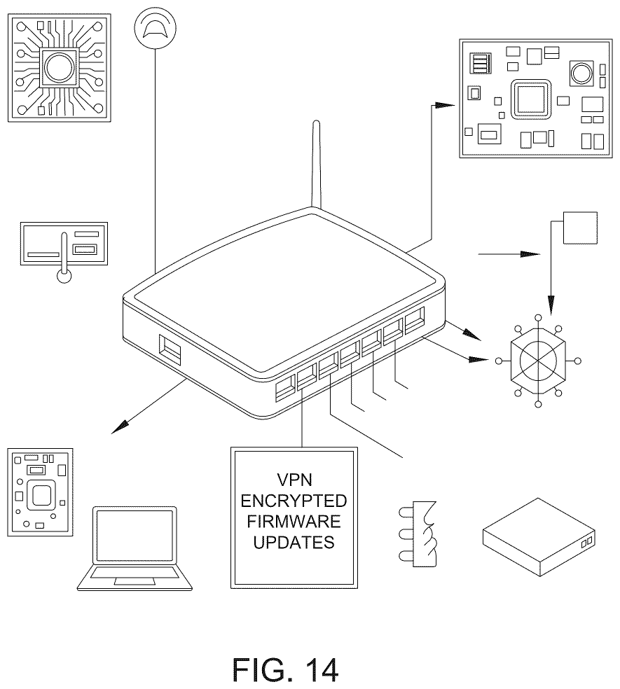

FIG. 15 Shows the router has a sleek rectangular shape with rounded edges, providing a contemporary look suitable for home or office environments. Four prominent antennas are situated on the top, enhancing wireless signal range and connectivity. The top features a circular Wi-Fi symbol, indicating wireless connectivity capabilities. In Connectivity Ports, multiple standard ethernet ports for wired connections. At least one USB port for connecting external devices. A power socket, easily identifiable for plugging into a power source. The router is highlighted as having integrated systems for both environmental sensing, monitoring parameters like temperature and air quality, and robust cybersecurity measures to protect connected devices.

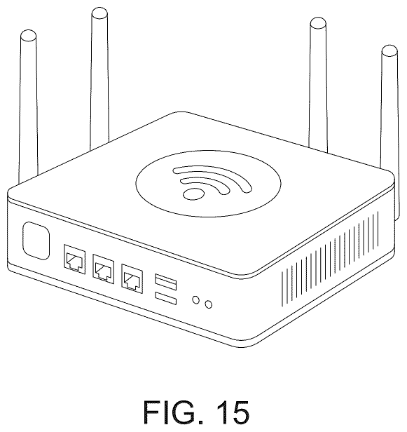

FIG. 16 Depicts a smart wireless router designed with a cuboid shape. The router features a circular area on its top surface, which may indicate an antenna or a functional component. A vertical pole extends from one side of the router, likely representing a communication tower or an environmental sensing component. The drawing includes a nearby tower with a structure typically associated with telecommunications, suggesting connectivity capabilities. The integrated environmental sensing system indicates a focus on monitoring environmental conditions (e.g., air quality, temperature). The cybersecurity system component suggests enhanced protection measures for data security and network integrity. This design illustrates an innovative approach to combining networking, environmental monitoring, and cybersecurity into a single device, enhancing both connectivity and safety.

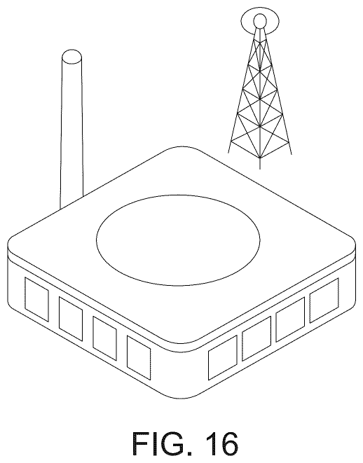

FIG. 17 Is a schematic representation of an AI-powered smart wireless router's internal components, specifically focusing on its power management system. Key Components are, Power Regulation Criticality, it Indicates the importance of power regulation in maintaining system stability. Power Regulation Circuit, manages the flow of power to ensure optimal performance and prevent system overloads. Power Corperter, Likely indicates a component responsible for distributing power across the router's various functionalities. Power Input, represents the entry point for power supply to the entire system. The drawing shows interconnected components with arrows indicating the flow of power and information between them. The design emphasizes the integration of different power management aspects crucial for maintaining the router's functionality, particularly in the context of environmental sensing and cybersecurity.

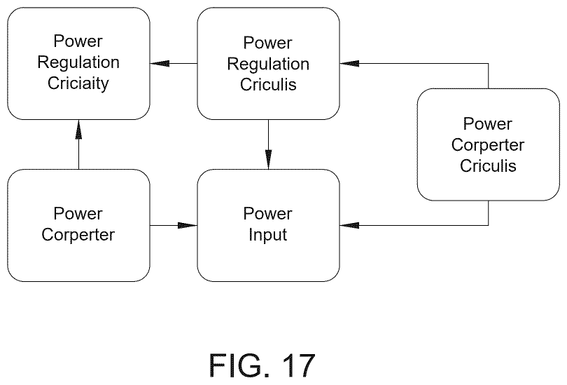

FIG. 18 Depicts a simple rectangular monitor that displays “POWER MANAGEMENT” at the top, along with three blank squares likely representing status indicators or options for power management settings. POWER MANAGEMENT” suggests the router includes functionalities for efficient power usage, potentially adapting energy consumption based on the detected environment or user needs.

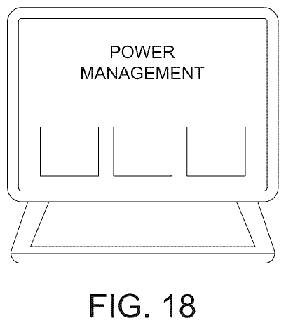

What is claimed is,:

1. A wireless router comprising,
(i) At least one processor.
(ii) an artificial intelligence module configured to optimize signal routing and bandwidth allocation.
(iii) a plurality of sensors comprising at least an RF signal sensor and an environmental sensor.
(iv) a cybersecurity module configured to detect and block malware using machine learning.
(v) a power management module configured to adjust power usage based on sensor input.
(vi) wherein the artificial intelligence module dynamically controls bandwidth allocation and security settings based on real-time data from the sensors and network activity.

2. The wireless router of claim 1, wherein the artificial intelligence module continuously analyzes network performance metrics to adaptively optimize Wi-Fi connectivity.

3. The wireless router of claim 1, wherein the environmental sensor monitors conditions such as temperature, humidity and occupancy to inform network adjustments.

4. The wireless router of claim 1, wherein the artificial intelligence module manages multiple RF frequency bands (e.g., 2.4 GHz and 5 GHz) to optimize network performance based on user demand and environmental conditions.

5. The wireless router method of claim 1, for detecting and mitigating cybersecurity threats in a wireless router, comprising,
(i) Implementing a cybersecurity module that employs machine learning algorithms to continuously monitor network traffic for anomalies.
(ii) Automatically blocking identified malware and potential threats based on real-time analysis without requiring manual intervention.

6. The wireless router of claim 1, wherein the artificial intelligence module manages bandwidth allocation for multiple Internet of Things (IoT) devices connected to the network.

7. The wireless router of claim 1, wherein the power management module adjusts power usage based on the number of connected devices and their activity levels.

8. The wireless router of claim 1, wherein the artificial intelligence module dynamically selects the optimal communication channel to minimize interference and maximize throughput.

9. The wireless router of claim 1, further comprising a user interface that provides real-time insights and recommendations for network optimization based on data collected from the sensors.

10. The smart wireless router of claim 1, further comprising an over-the-air (OTA) firmware update mechanism based on AI-detected performance metrics and vulnerabilities.

11. The wireless router of claim 1, further comprising a mechanism for automatically updating firmware based on detected vulnerabilities and performance improvements identified through machine learning analysis.

12. The wireless router of claim 1, wherein the artificial intelligence module optimizes power consumption based on historical network usage patterns to enhance energy efficiency.

13. The smart wireless router of claim 1, wherein encrypted DNS and VPN routing features are selectively enabled or disabled by the AI engine in response to real-time threat assessments.

14. The smart wireless router of claim 1, further comprising a mobile application configured to provide real-time alerts, network monitoring, environmental readings, and remote device management.

15. The smart wireless router of claim 14, wherein the mobile application displays AI-generated network anomaly reports and allows user override of prioritized bandwidth and security configurations.

16. The smart wireless router of claim 1, wherein the environmental sensors trigger automated control signals for one or more smart devices, including HVAC systems, smart blinds, or air purifiers.

17. The smart wireless router of claim 16, wherein the AI engine communicates with smart home platforms using one or more protocols including Zigbee, Z-Wave or Matter.

18. The smart wireless router of claim 1, wherein the AI engine dynamically assigns priority levels to connected devices based on device classification, usage history, and real-time network demands.

19. The smart wireless router of claim 18, wherein the router maintains a prioritized traffic shaping queue that preempts non-critical traffic in favor of latency-sensitive applications.

20. The smart wireless router of claim 1, wherein the router initiates scheduled security scans of connected IoT devices and enforces quarantine protocols for compromised endpoints.
